(19) United States
(12) Patent Application Publication
(10) Pub. No.: US 2015/0170115 A1
(43) Pub. Date: Jun. 18, 2015

(54) LEARNING MANAGEMENT, COMMUNICATION, AND REWARD SYSTEM AND METHOD

(71) Applicant: Mark Lacek, Minneapolis, MN (US)

(72) Inventor: Mark Lacek, Minneapolis, MN (US)

(21) Appl. No.: 14/327,259

(22) Filed: Jul. 9, 2014

Related U.S. Application Data
(60) Provisional application No. 61/917,937, filed on Dec. 18, 2013.

(51) Int. Cl. G06Q 20/04; G06Q 30/02

(52) U.S. Cl. CPC G06Q 20/045; G06Q 30/0226; G06Q 30/0279

(57) ABSTRACT

A mobile and web-based personal goal system for families that rewards children or other family members for completing tasks in the areas of academics, health, finances and money, family, and community. The system offers families a consistent way to interact offline and online regarding children's choices and a way to reward them for those choices. Multiple children can be members of one family account, frequently referred to as a sponsor account.

### CROSS-REFERENCE TO RELATED APPLICATIONS

This application claims the benefit of U.S. Provisional Application No. 61/917,937, filed Dec. 18, 2013, titled Learning Management, Communication, and Reward System and Method.

### BACKGROUND OF THE INVENTION

Parents aim to raise theirs children to be intelligent, valuable, contributing members of society. They also wish to maintain an open dialogue with their children and nurture a healthy relationship. The present invention generally relates to a system and method that rewards children for making positive life choices. More specifically, it relates to a system and method that allows children to complete tasks in areas such as academics, health, finances and money, family, and community and earn points from a parent or sponsor who has previously paid for the points. The child can then redeem those earned points for items of value.

### SUMMARY OF THE INVENTION

The following disclosure explains a mobile and web-based personal goal system for families that rewards children or other family members for making positive life choices. The system offers families a consistent way to interact offline and online regarding children's choices and a way to reward them for those choices. Multiple children can be members of one family account, frequently referred to as a sponsor's account.

### BRIEF DESCRIPTION OF THE DRAWINGS

FIG. 1 is an example graphical user interface showing a mobile interface screen according to one embodiment of the present invention.

FIG. 2 is an example graphical user interface showing a mobile interface screen according to one embodiment of the present invention.

FIG. 3 is an example graphical user interface showing a mobile interface screen according to one embodiment of the present invention.

FIG. 4 is an example graphical user interface showing a mobile interface screen according to one embodiment of the present invention.

FIG. 5 is an example graphical user interface showing a mobile interface screen according to one embodiment of the present invention.

FIG. 6 is an example graphical user interface showing a mobile interface screen according to one embodiment of the present invention.

FIG. 7 is an example graphical user interface showing a mobile interface screen according to one embodiment of the present invention.

FIG. 8 is an example graphical user interface showing a mobile interface screen according to one embodiment of the present invention.

FIG. 9 is an example graphical user interface showing a mobile interface screen according to one embodiment of the present invention.

FIG. 10 is an example graphical user interface showing a mobile interface screen according to one embodiment of the present invention.

FIG. 11 is an example graphical user interface showing a mobile interface screen according to one embodiment of the present invention.

FIG. 12 is an example graphical user interface showing a mobile interface screen according to one embodiment of the present invention.

FIG. 13 is a schematic block diagram illustrating a sponsor's sign-in process according to one embodiment of the present invention.

FIG. 14 is a schematic block diagram illustrating a sponsor's homepage options according to one embodiment of the present invention.

FIG. 15 is a schematic block diagram illustrating how a sponsor can view and edit a Child's Task List according to one embodiment of the present invention.

FIG. 16 is a schematic block diagram illustrating how a sponsor reviews a child's completed task according to one embodiment of the present invention.

FIG. 17 is a schematic block diagram illustrating a child's sign-in process according to one embodiment of the present invention.

FIG. 18 is a schematic block diagram illustrating a child's homepage options according to one embodiment of the present invention.

FIG. 19 is a schematic block diagram illustrating the process of completing a task according to one embodiment of the present invention.

FIG. 20 is a schematic block diagram illustrating how to send and view messages according to one embodiment of the present invention.

FIG. 21 is a schematic block diagram illustrating options available to a child in a task list according to one embodiment of the present invention.

FIG. 22 is a schematic block diagram illustrating how to view a child's activities according to one embodiment of the present invention.

FIG. 23 is a schematic block diagram illustrating how to add and edit goals according to one embodiment of the present invention.

FIG. 24 is a schematic block diagram illustrating options available in a child's points bank according to one embodiment of the present invention.

FIG. 25 is a schematic block diagram illustrating how to use the disclosed system's web-based graphical interface according to one embodiment of the present invention.

FIG. 26 is a schematic block diagram depicting an example computing system used in according with one embodiment of the present invention.

### DETAILED DESCRIPTION

Reference is made throughout the present disclosure to certain aspects of one embodiment of the system described herein. Such references to aspects of the presently described system do not limit the scope of the claimed invention. Additionally, any examples set forth in this disclosure are not intended to be limiting and merely set forth some of the many possible embodiments for the invention. It is to be understood that the phraseology and terminology used herein are for the purpose of description and should not be regarded as limiting.

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims. It is understood that various omissions and substitutions of equivalents are contemplated as circumstances may suggest or render expedient, but these are intended to cover applications or embodiments without departing from the spirit or scope of the claims attached hereto. Also, it is to be understood that the phraseology and terminology used herein are for the purpose of description and should not be regarded as limiting.

Throughout the following disclosure, “Sponsor” may be used as the generic term for any person who sponsors, and therefore funds, points for a user. In a similar manner, “Child” may be used as the generic term for any person who uses the disclosed system and method to earn points. The following key terms are used throughout the document, which represent one embodiment of the invention:

Sponsor—A Sponsor represents the primary account holder for a Member. The Sponsor may be one or more parents or guardians that use a single sponsor-account login. The Sponsor can provide a form of payment that funds the account. A Sponsor may have one or more Members and/or Free Accounts associated with their Sponsor account. The disclosed system, in some embodiments, refers to Sponsors as “parents.”

Child—A Child represents one Member that is participating in the program. A Child can earn points from an account that is funded by his or her Sponsor. A Child may have only one Sponsor; Children associated to multiple Sponsors will have separate Child accounts. However, Children may be able to “subscribe” to content created by other Sponsors or third parties.

Member—A Member is a general term for the individual user. Both Sponsor and Child users are considered Members.

Free Account—A Free Account represents a Child that is participating in the program earning Free Points for various activities. A Free Account has no form of payment associated with a Sponsor's account or the form of payment has expired. A Free Account may have only one Sponsor.

Funded Points—Funded Points have a monetary value. They come from a Sponsor's account when one or more active forms of payment are registered to the Sponsor's account. Funded Points that are earned by a Child transfer from a Sponsor's account to the Child's account. Funded Points can be redeemed, saved, or shared (i.e., donated).

Sponsor Points—Sponsor Points represent the available Funded Points that have been charged to the Sponsor's form of payment but have not yet been transferred to the Member's account as Funded Points.

Saved Points—Saved Points represent Funded Points for a Member that are allocated to savings. Saved Points can be automatically accrued based on a percentage of each Funded Point earning. Sponsors can set a minimum percentage of Funded Point earnings to accrue as Saved Points.

Shared Points—Shared Points represent a Member's Funded Points that are allocated to sharing. Shared Points can automatically accrue based on a percentage of each Funded Point earnings. A Member may also trade Funded Points for additional Shared Points on demand.

Free Points—Free Points represent points earned in a Free Account. Free Points have no monetary value, but may be included for promotional opportunities.

Gift Points—Gift Points represent Funded Points added to a Member's account from a gift by a third party. A Member must still earn Gift Points. Gift Points can be purchased on a host website or at select retail locations. Gift Points can be added to a Member's account by entering a code assigned to the purchase. Gift Points can be added in a pending state and transferred to the Member's account as Funded Points are earned. For example, if a Member has Gift Points, they can receive a Gift Point for each Funded Point they earn until the Gift Points are depleted, essentially earning “double points.” In some embodiments, Gift Points cannot be earned in a Free Account.

Sponsored Points—Sponsored Points are points funded by a third party in exchange for completing a task. An example of this might be a Bank that sponsors 100 points to Children who complete a financial literacy task and open a savings account.

Family Points—Family Points represent a way that families can create their own currency. In other words, they allow Children to redeem their points for non-monetary rewards within the family. The application allows users to customize these rewards. Family Points can represent things like screen time, playtime, or any other non-monetary family-based reward.

Recruit—A Recruit is a Member who is set up as an active referral source to another Member account. A Member may be a Recruit to only one Member. A Recruit to Member relationship cannot exist between two Members under the same Sponsor. Once a Recruit is inactive they cannot become a Recruit again.

### General Background

The disclosed system is a point-based system that offers Children a variety of positive activities that they can complete. Once a Child completes an activity, the system helps the Child send the Child's Sponsor a message letting the Sponsor know what specific activity has been completed. The message can include the Child's request for the points associated with the completed activity and the option to send a message to the Sponsor. Sponsors can receive this type of notification directly on a device such as a cell phone or through email. Upon receiving the notification, a Sponsor can see what the Child has done and can award the Child the points, deny the request, or ask to “discuss” prior to approval. In addition to approving points, Sponsors can send a message to the Child regarding the one or more activities the Child has completed. This method of having a Child send a message to the Sponsor and allowing the Sponsor to approve points with one click on their mobile device helps parents maintain consistency. It also helps create a positive dialogue between Sponsors and Children.

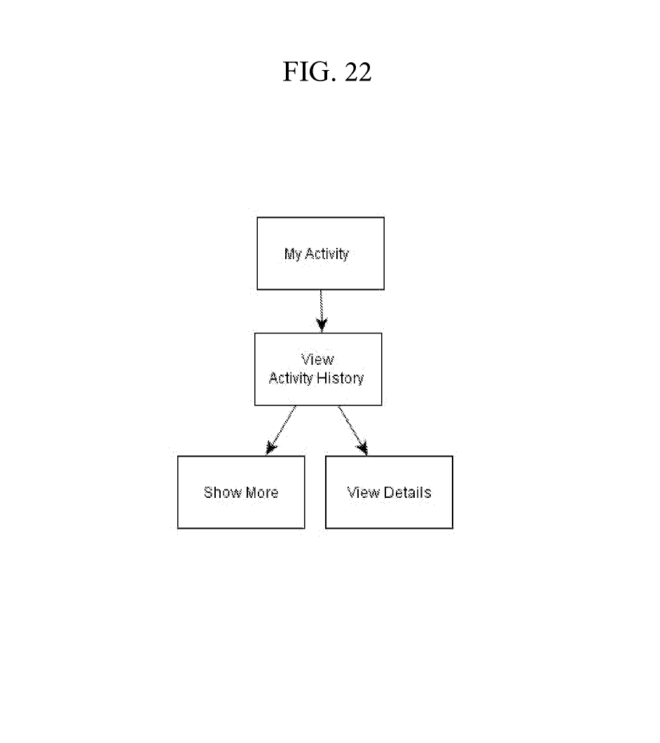

The types of activities that a Child can complete with the disclosed system are practically infinite. Examples of activities a Child can complete with the system include, but are not limited to, reading a book, doing a chore around the house, participating in an online module teaching financial literacy, exercising, or even practicing social graces. Within the system, the Child can view his or her activity history, as illustrated in FIG. 22. The system promotes Children to be well-rounded contributors to society. In support of a well-rounded Child, the system provides activities under categories such as, but not limited to, academics, health, finances and money, family, and community. In some embodiments, the primary categories may be, for example, Academics, Health, Money, Family, and Community. Under these categories, a myriad of tasks and learning opportunities can be provided. Certain embodiments of the invention may include these categories as well as other categories, or may include only categories other than those listed here. The five listed categories are set forth as examples of categories which may be included.

Once a Child accumulates points, the Child can redeem those points for a number of options all having real cash value. The system has a variety of redemption options that include, but are not limited to, purchasing online merchandise, purchasing a physical or electronic gift card to a retailer, transferring money into a bank or internal savings account, transferring money onto a debit card, and donating to one or more charities. Parents can provide a form of payment to fund the points, which can include, but are not limited to, a credit card, debit card, PayPal account, ACH transfer, ETF transfer or the use of a secondary currency such as that from a bank, hotel, airline, retail or other loyalty program account (e.g. using US Bank FlexPerks points to fund a Child's points/account in this system).

By engaging with the system, Children learn money management skills in addition to the other opportunities offered. Specifically, they learn how to earn, save, and spend points for real merchandise, gift cards, and gift certificates. The disclosed system encourages all Members to manage their points with a Save, Spend, Share model. In one embodiment, the system has a default set in place for accounts that automatically puts 5% of earned points into each of the Save and Share accounts and 90% of the points into the Spend account. These default settings can be changed by the system or the Sponsor at any time. Save points can be transferred into a savings account, a 529-college savings plan, a Child's Spend account, onto a debit card, or into a Member's Share account. Share points can be donated to charities by equally allocating amongst the various choices or allocating to the various options based on the Child's preferences.

The system has default settings that make using it easy to use for both Sponsors and Children. In order to comply with COPPA, a parent will complete a registration process for Children under the age of 13. Children over 13 can complete registration themselves. Once completed, a Child under 13 will be able to participate with the system and will be notified by text, email, or in person that they are registered and can begin utilizing the system. A user name and password will need to be utilized to gain access to a Child's account. Sponsors and Children will each have their own user name and password to gain access to their respective sections of the system account. If a Sponsor would like to be more involved with the system, the Sponsor can customize the entire experience. Some of the customizable features include, but are not limited to (1) limiting the categories in which a Child can earn points; (2) moving a Child up or down a grade in approved academic activities; (3) increasing or decreasing point values for certain activities; (4) creating customized tasks that are eligible for points; (5) changing the allocation of points that are automatically Saved or Shared; (6) offering double points (or other metric) for activities; (7) determining the frequency by which a Child can request point approvals; and (8) putting a time limit on when a task is eligible for earning points (e.g. “you can earn “x” points for “y” if successfully completed by “z” date/time”).

Navigation

Two distinct views, a Sponsor view and a Child's view, exist for the disclosed system. Each view is designed to meet the needs of the specific functions required by each respective role. There are two main navigational menus for each view. While the overall user experience is consistent, each role has its nuances.

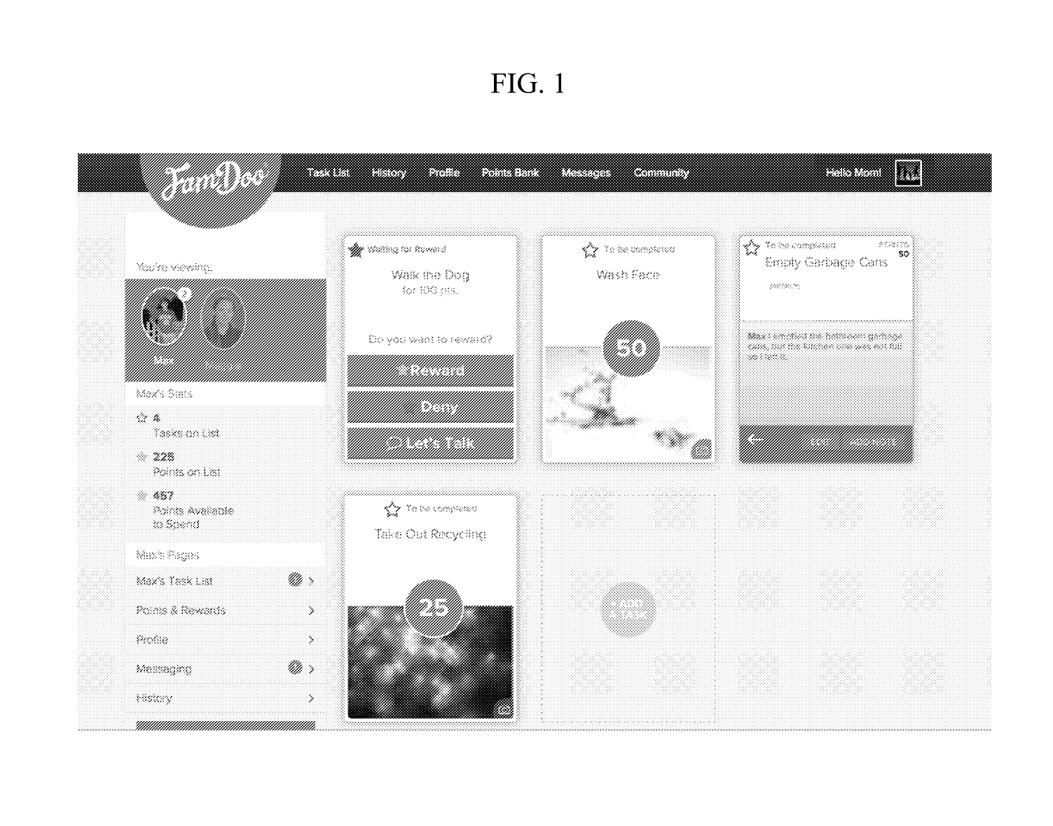

The Sponsor's view, as illustrated in FIGS. 1, 2, 4-9, and 11, is designed to allow each Sponsor to manage his or her profile, manage Children's profiles, add Children, see interaction history, and view and manage points and Child Reward Requests. In addition, the Sponsor's view allows a Sponsor to switch between Children and view and manage each Child's Task List. It also allows the Sponsor to manage a Child's profile, pin number, goals, contact information, etc. A Sponsor can switch between Children at any time. The Sponsor view also allows Sponsors to send messages to Children, give Bonus Points, or add tasks. The Sponsor has administrative privileges over all of their Children's accounts.

The Sponsor view has three main components: the Dashboard, the Child selector/navigation, and the Child Task List.

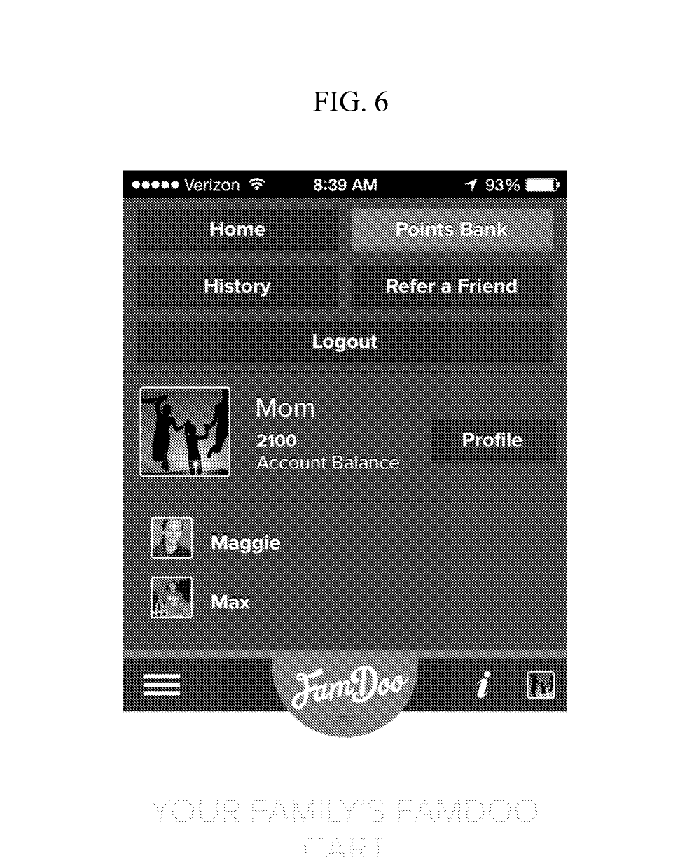

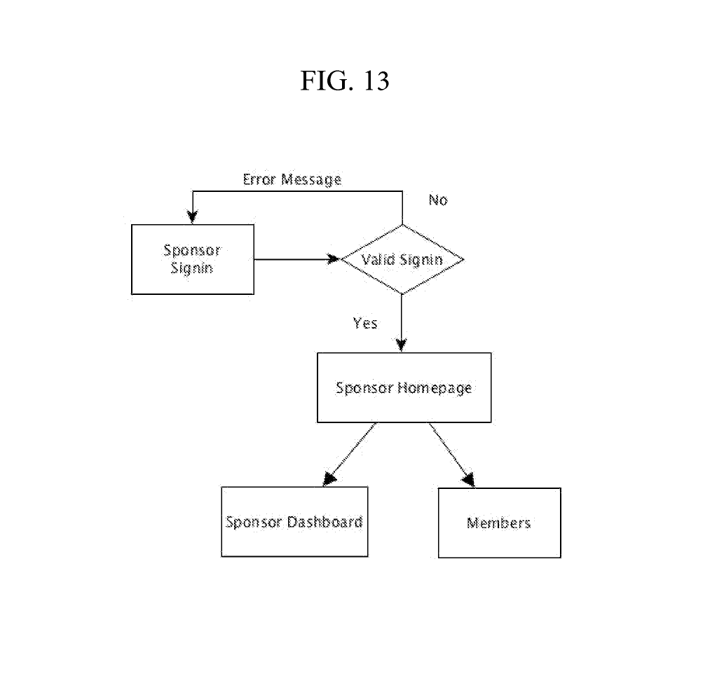

The Dashboard, as illustrated in FIG. 6, represents information germane to the Sponsor. This view includes navigation to locations such as, but not limited to, Summary for Member, Home, History, Points Bank, Refer a Friend, Profile, and Logout. To access the Dashboard, a Sponsor will sign in with the proper credentials and select the Dashboard from the Homepage, as illustrated in FIG. 13.

The Summary for Member navigation, as illustrated in FIG. 1, includes information about a Child such as, but not limited to, the Child's first and last name, the Child's background photo, the Child's points summary, and an indicator to show the number of unread messages. The Sponsor can upload a photo for the Child's background photo or can select from a list of avatars. A default background can be used when no photo has been uploaded or avatar selection has taken place. The points summary can show earned points, spent points, shared points, saved points, and available points. The indicator showing the number of unread messages can be clicked to bring up the corresponding messages.

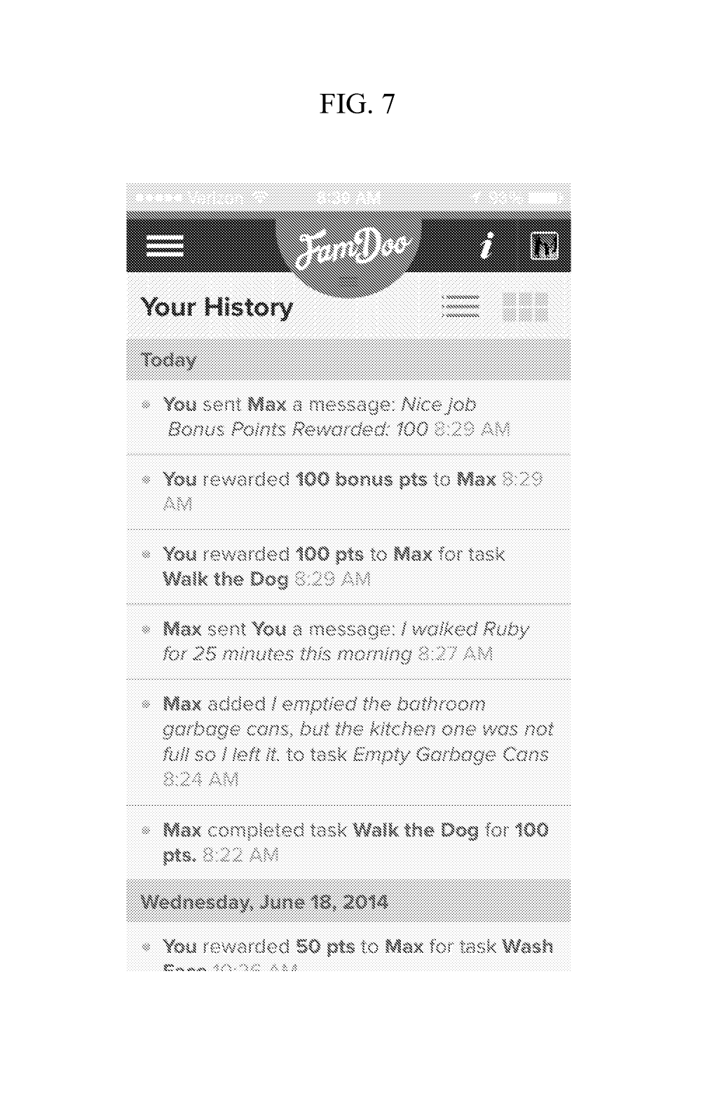

The History navigation, as illustrated in FIG. 7, allows a Sponsor to view, sort, or filter historical content such as, but not limited to, tasks and messages. The Sponsor can see how each Tasks status has changed over time and when messages were sent. Additionally, the Sponsor can select an old message to open it and view the entire message. Within the History navigation, the Sponsor can also send a new message. New messages can have a subject line and a region where the body of the message can be typed. Messages are sent using the send button and, once sent, message cannot be updated. In some embodiments, visual indication will be used to show if a message is unread versus read.

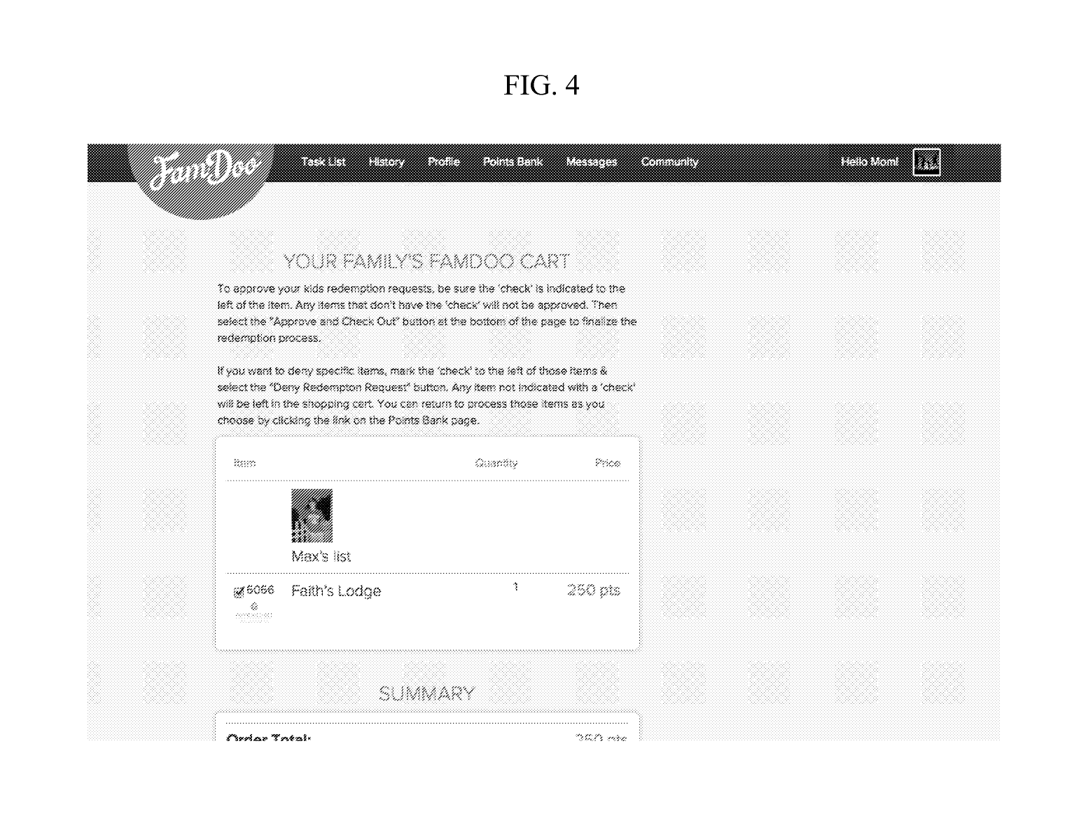

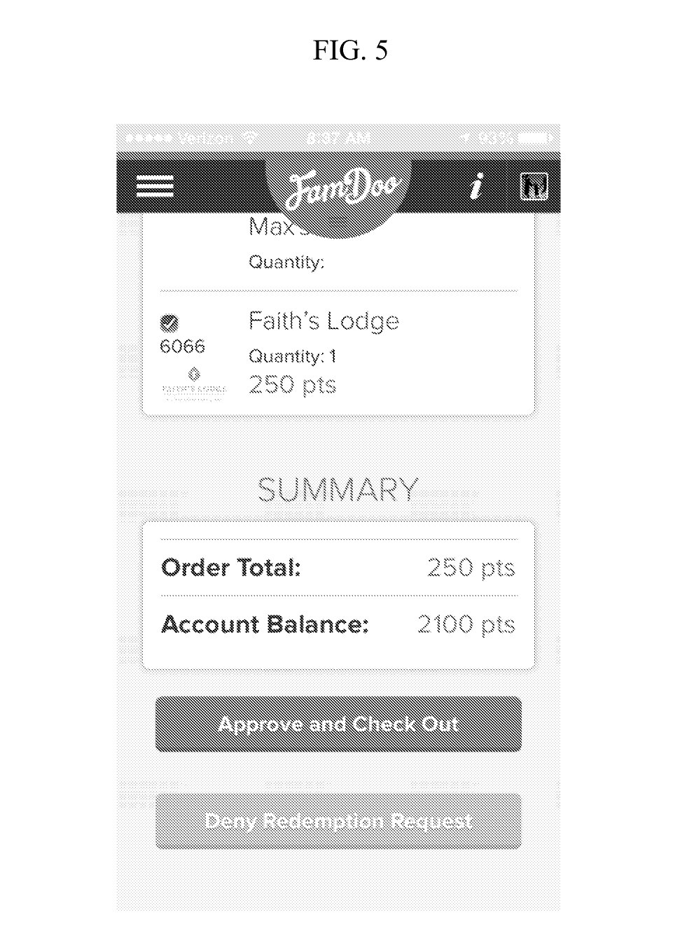

The Points Bank navigation allows the Sponsor to transact, view, and otherwise manage all point and financial transactions such as, but not limited to, purchasing points, verifying an account, entering promotional codes, and approving redemptions. Account verification allows Sponsors to pay a fee in order to prove guardian status. Once verified, both Sponsors and Children can send messages to each other and add their own photos. Promotional codes are entered to allow for promotional redemption. The process of approving redemption involves Sponsors viewing redemption requests from a Child, as illustrated in FIG. 4, and approving and transacting the request, as illustrated in FIG. 5.

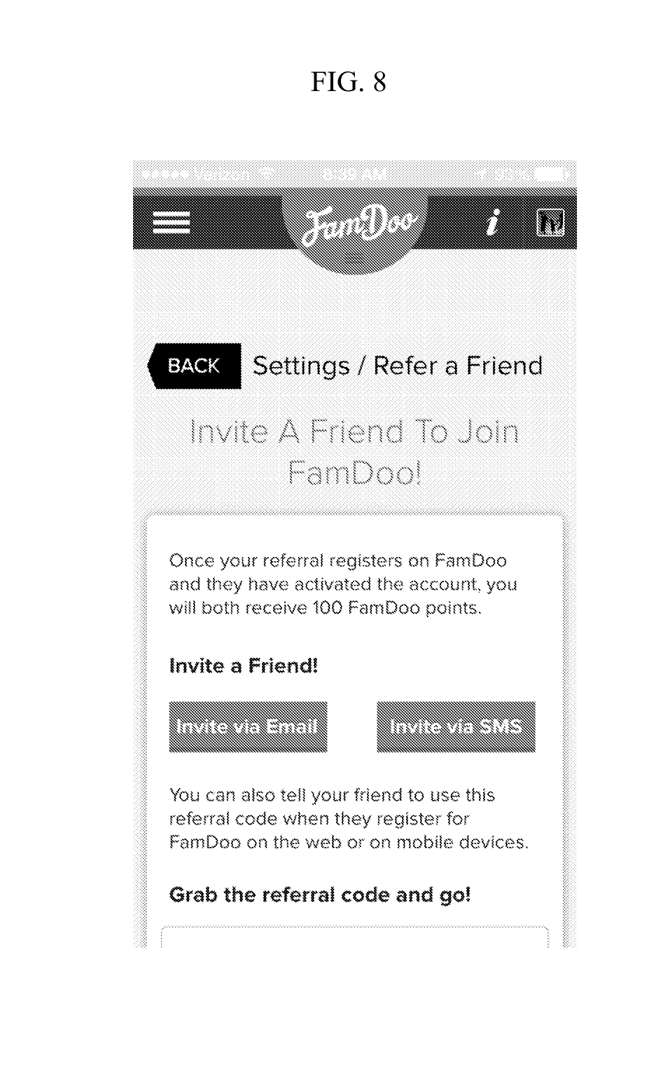

In some embodiments, a Sponsor can help a Child refer a friend through the Refer a Friend navigation, as illustrated in FIG. 8. The Sponsor can have a specific referral code that, when shared with the Child, allows the Child to invite other Children to the system via email, SMS, or by providing a friend with the unique code in some other form. The code allows the Child to receive referral reward points.

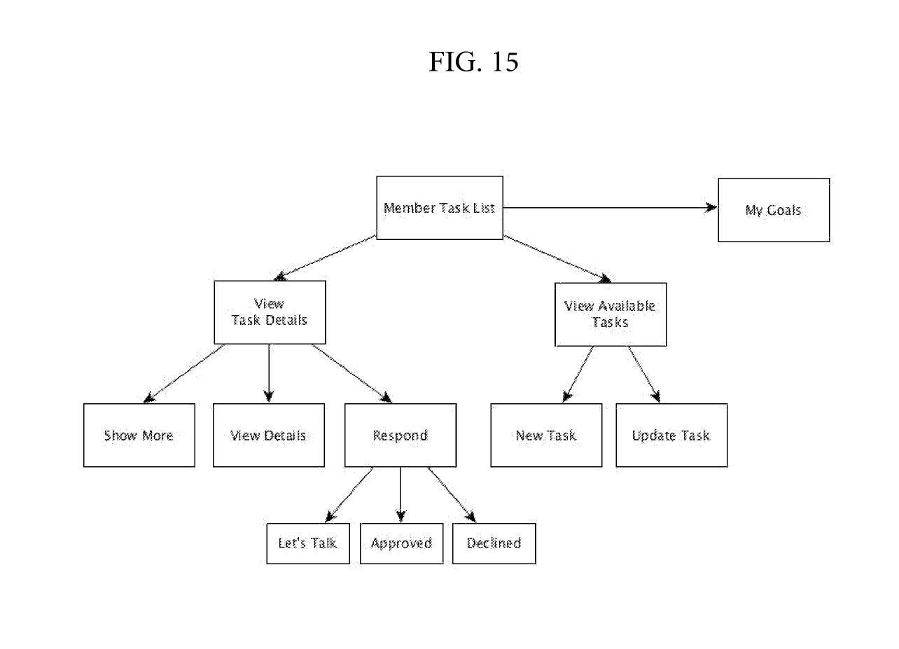

The Child selector/navigation allows Sponsors to select which Child's Task List and information they want to view, edit, message, or interact with, as illustrated in FIG. 15. More specifically, Sponsors can navigate to a Child's task details, available tasks, and goals from the Child's Task List. Within the task details view, a Sponsor can show more of the view, view task details, or respond with “Let's Talk,” “Approved,” or “Declined.” Within the available tasks view, a Sponsor can create a new task or update an existing task.

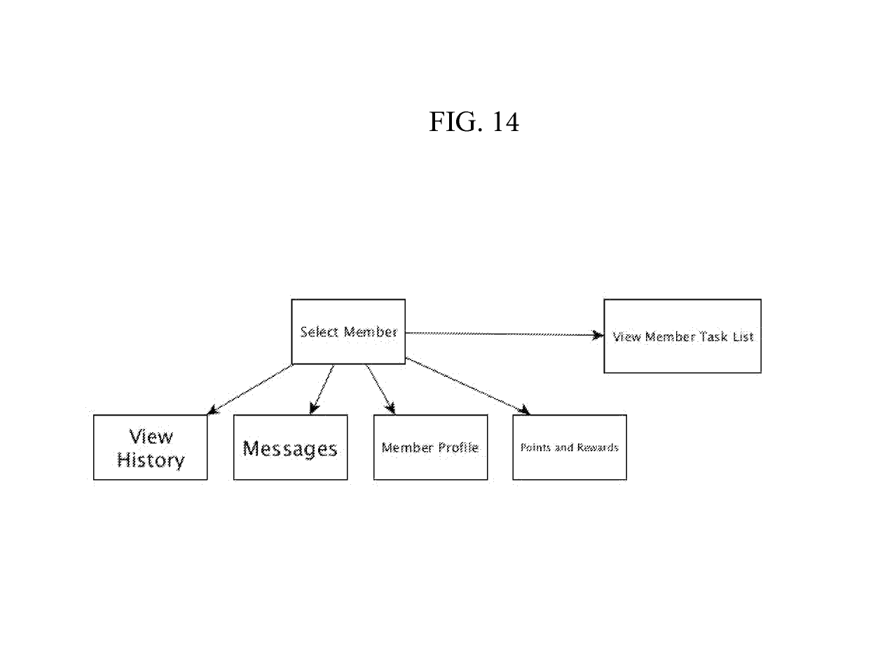

Within the Child selector/navigation, the Sponsor can view names and photo identifiers of individual Children. Once highlighted, Children's statistics along with their corresponding Task Lists can be shown, as illustrated in FIG. 1. In this view the Sponsor can navigate to areas such as, but not limited to, Points & Rewards, Messages, Profile, and History, as illustrated in FIG. 14. In addition, Sponsors can complete actions from this view such as, but not limited to, sending a message, giving a bonus, and adding a task, which is described in more detail elsewhere in this disclosure.

The Points & Rewards view allows Sponsors to view a Child's spendable points, points earned that month, and Reward Requests that are awaiting approval. In addition, Sponsors can see how many points the Child has accrued in the Child's Spend, Share, and Save categories, and can view the available spending options under each category.

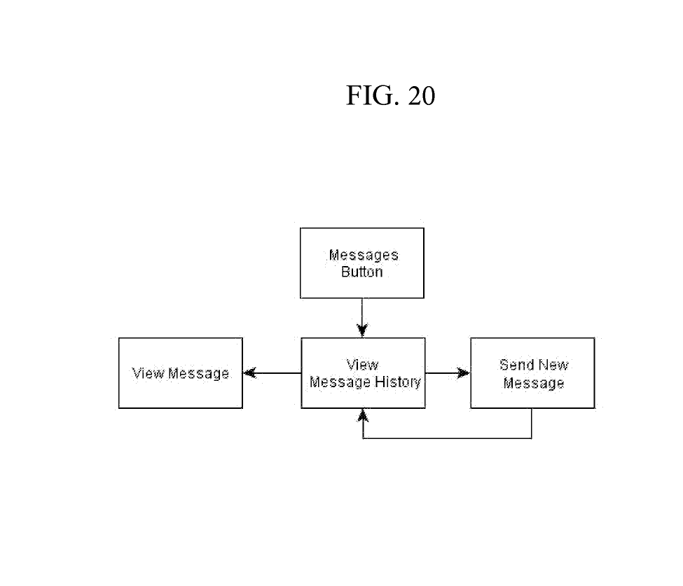

The Messages view sorts all messages, photos, and notes associated with the selected Child. It also allows Sponsors to draft messages to send to the Child, to view overall message history, and to view specific messages that have been sent, as illustrated in FIG. 20. Messages can be sent directly to the Child through the system and through push message to the selected Child. Additionally, Sponsors can attach a photo to the message as part of the overall messaging thread.

The Profile view allows Sponsors to view and edit a Child's profile information. Profiles allow the system to deliver a more customized interaction. For example, academic tasks can populate automatically for the appropriate grade level of the Child. The profile can include information such as, but not limited to, the Child's first and last name, user name, birthday, gender, grade, pin number function, mobile number, and email password. In addition, Sponsor's can view or edit information about a Child's goal such as, but not limited to, the name of the goal, the goal point total, the goal image, and the graphic image representing progress to the goal. In some embodiments, the Profile view allows Sponsors to set and edit the percentage of earned points that automatically allocate into the Save, Spend, and Share categories. This allocation populates the appropriate areas in the Child's Points Bank.

The History view from the Child selection/navigation is similar to the History navigation described above. However, the History view from the Child selection/navigation is filtered for the selected Child.

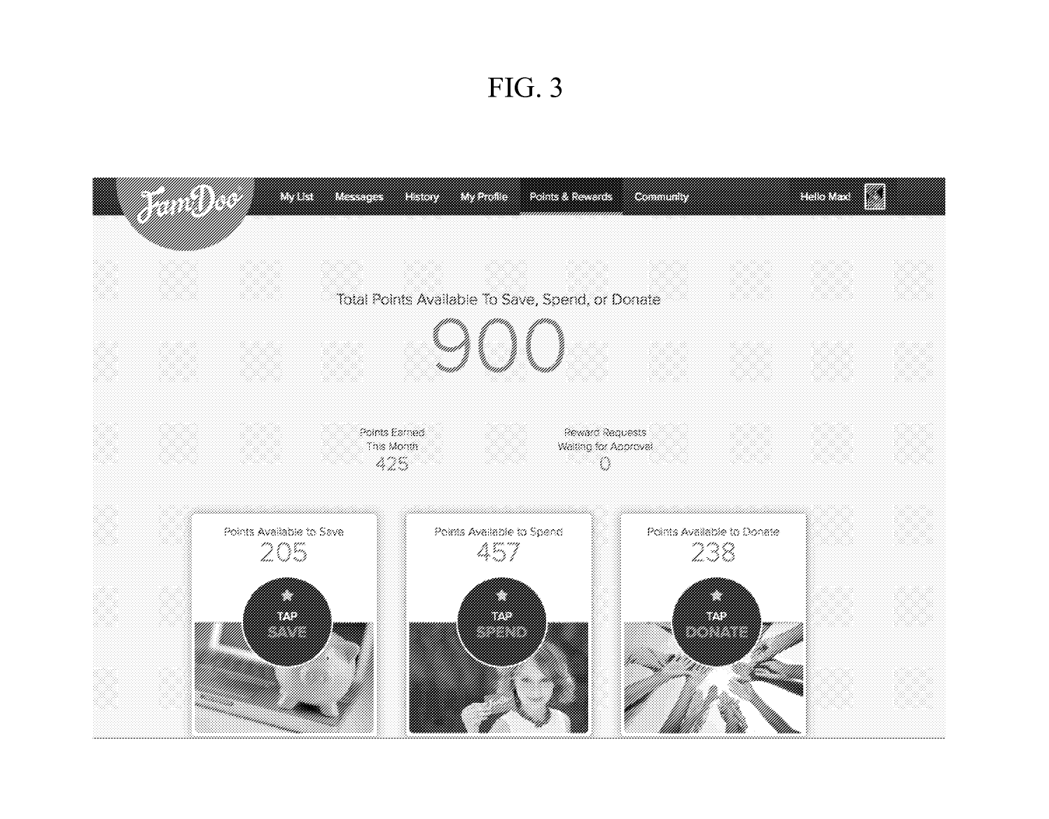

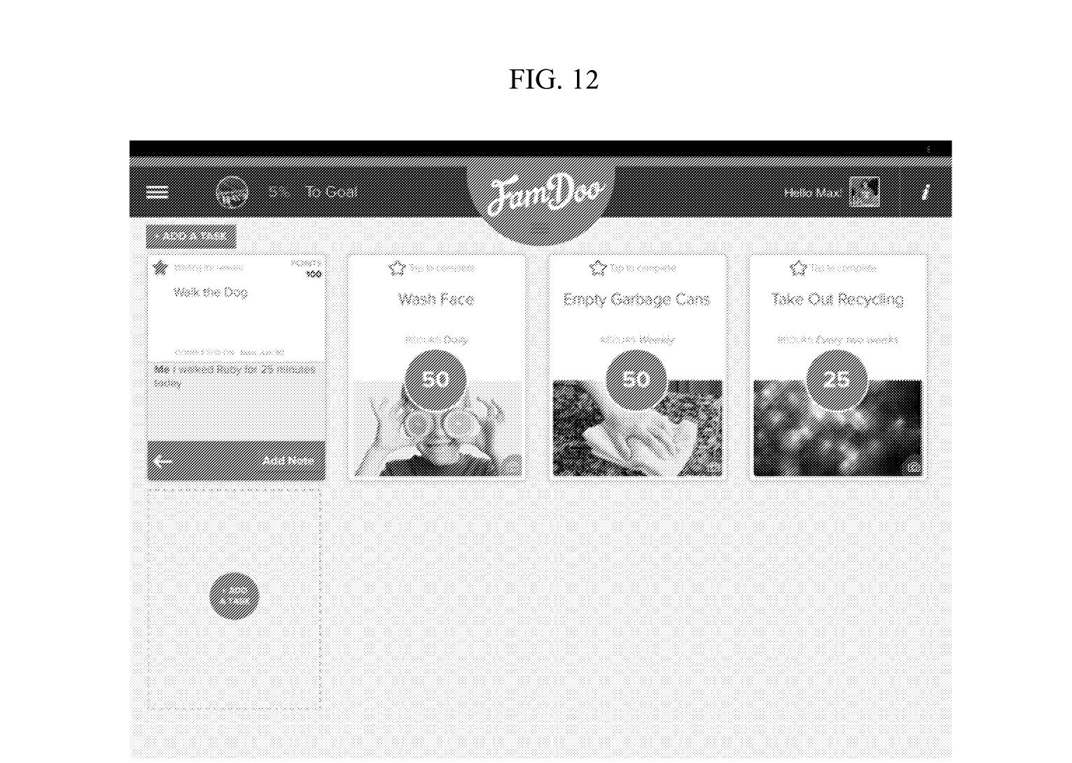

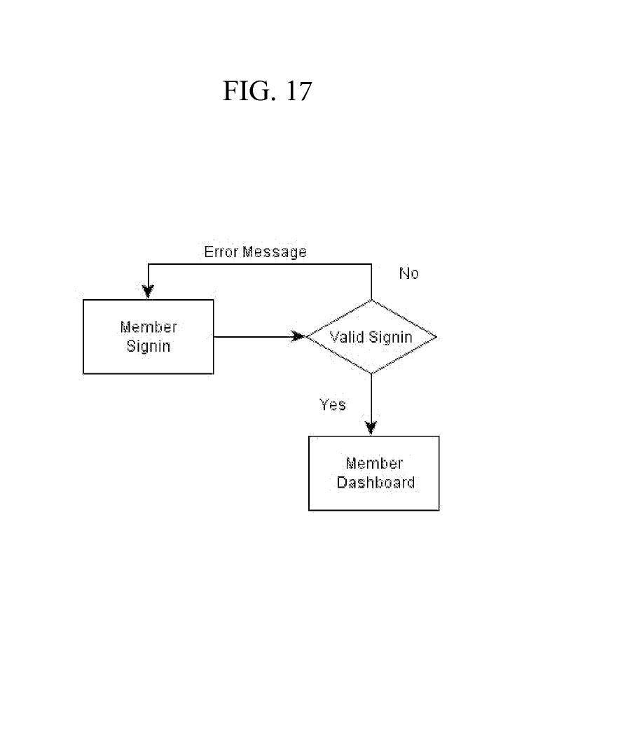

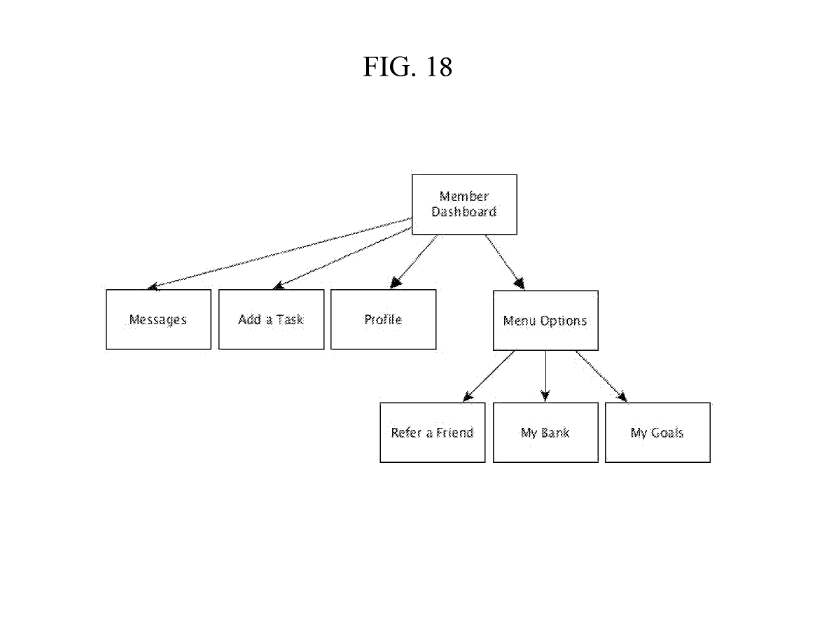

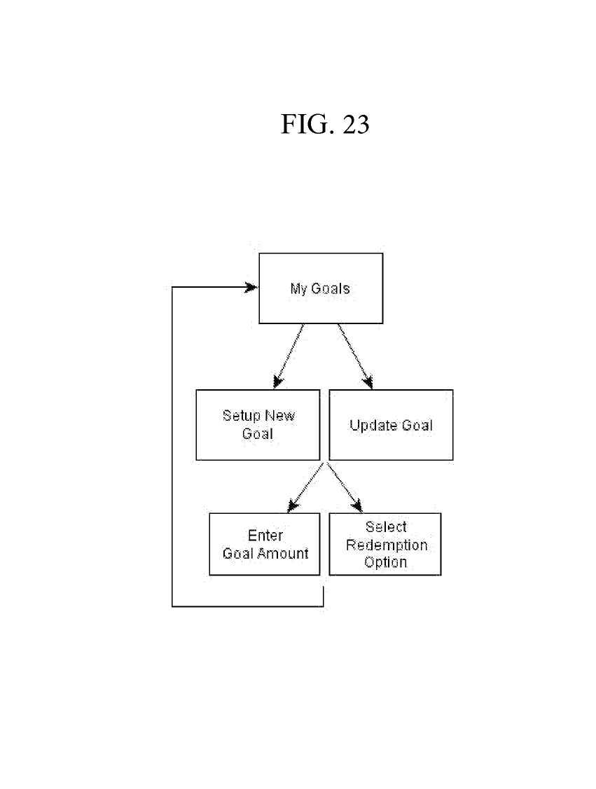

The Child view of the Dashboard is functionally and experientially similar to the Sponsor view. Additionally, similar to the Sponsor view, to access the Dashboard, a Child will sign in with the proper credentials and select the Dashboard from the Homepage, as illustrated in FIG. 17. However, there are slight differences that create a different user experience for Children. In the Children's view, a Child can navigate to areas such as, but not limited to, Messages, Task List, Profile, History, Point & Rewards Bank, Refer a Friend, My Profile, Goals, and Logout, as illustrated in FIG. 18. An example of the Child's view of the Task List is illustrated in FIG. 12. An example of Child's view of the Points & Rewards Bank view is illustrated in FIG. 3. Functionally, each navigation screen remains consistent with the Sponsor views described previously. Children, however, are able to view, but not edit, their Save, Spend, and Share points before they are allocated. In addition to the above listed navigation areas, a Child can create and view a goal, as illustrated in FIG. 23.

A goal is a point total defined by the Child or Sponsor. These point totals can include totals in the Spend, Save, Share, or any combination of those categories. The system can then tracks the progress to the goal automatically as the Child accrues points. Goals can include a description, image, or both. The Sponsor or Child can customize the image, or can choose it from a gallery. Goals can be displayed graphically, which can provide motivation for Children to complete their tasks and earn points. From the Dashboard, a Child can set up new goals or update current goals, as illustrated in FIG. 23. Within a goal setup or update, the Child can enter the goal amount and a redemption option.

General Use

In some embodiments, the disclosed system allows parents and Children to create a goal together. Subsequently, the system will track a Child's progress towards achieving this goal. A goal can be customized for each Child. For example, a goal could be earning enough points to purchase an iTunes gift card. Another example of a possible goal is completing 30 activities in one month. A goal can be set for any activity that is possible for the system and can apply to either the Save, Spend or Share categories.

In some embodiments, the disclosed system is primarily used for Children in grades K-12. The system can be offered for Children in English and Spanish and can also be offered in most major languages throughout the world. Once a Child is signed up, suggestions of activities will be made for the Child based on age and grade level. Children can complete modules online on devices such as a smartphone, tablet, laptop, desktop, a computer or any other media device that allows access to the Internet. If a Child expects to be without an Internet connection for a period of time, the Child can pre-download modules onto the mobile or other Internet-enabled device so that they can continue utilizing the system even without an Internet connection. At a later time, the Child can re-connect and update the system to reflect any partially or fully completed activities.

Many game tactics are incorporated into the system. These tactics create a more engaging experience for Children and encourage them to use the system more frequently. Layered on top of the intrinsic game nature of a loyalty platform, this unique system will have many features that enhance the gaming aspect. Examples of these features include, but are not limited to, the following: a badging system recognizing status and achievement, special issues challenges, goal tracking, time tracking, a comparison feature to show how a Child is doing compared to others of the Child's age, avatars for each Child, live data reflecting how many points are in each account, and point calculators that help Children determine what they can do to earn specific items. Blogs about the system will be provided along with all of the best practices of social networks and online games. Children will be able to collaborate with other members to earn points or achieve goals, rate the modules they use or activities they undertake, blog and communicate to other members within the system's community, and other generally accepted social network and gaming activities.

The disclosed system includes an algorithm for how Children are awarded points for each module completed online The system tracks how long it takes a Child to complete a certain module and can award point values based on amount of time spent, difficulty, or the accuracy of responses. If the Child completes the module too quickly, that Child can be rewarded fewer points. On the other hand if the system detects that the Child is being challenged and putting in considerable effort, that Child can be awarded a higher level of points than is considered standard. The system is designed to recognize, and can subsequently reward, varying levels of challenge and effort.

Specific functions such as “Chores” or “Tasks” can be structured such that the parent can request or require a Child to submit completed tasks for a specific day by a certain time that day. This enables a Sponsor to approve a Child's points for that day and prevents a Child from requesting approval for points “earned” previously that would be difficult to validate by a Sponsor. This can increase the engagement of the Child and the control of the Sponsor over ensuring compliance with timely tasks.

The system has features that can prevent Children fraudulently obtaining points. These features include, but are not limited to, use of a webcam that is able to take a photo of who is completing the activities or who has completed the activity (e.g. a picture of a clean bedroom). The system is also able to capture a screen shot that includes a time and location stamp. If a Sponsor suspects that a Child is having another person do the work, then the Sponsor can check the screen shot to confirm the accuracy of the data. Sponsors will have the option to approve only points that they believe were completed by the Child that submitted the work.

The disclosed system has a Child's news feed that provides current event news written at age appropriate reading and comprehension level. After reading articles in the news feed, Children can be given a quiz to prove they read the article. News content can be curated for appropriateness of subject matter as well as comprehension difficulty. This news element can contain current events and timely news along with archived reports of previous events or stories that may or may not be time sensitive.

The disclosed system has activities that can be done both individually and collaboratively. For example, a collaboration activity may require that a Child teach a sibling a math concept or it might require that three people read the same book and discuss one of the themes.

Given the amount of books available to Children on and off the system, the system can test whether a Child read any book. This process also helps create a dialogue between the Sponsor and Child. One example of this process is as follows:

A Child finishes a book and tells the system whether he or she would like to answer questions electronically or by discussing with a Sponsor. If the Child wants to answer electronically, he or she can receive a random set of book-related questions from the system. The Child can then answer the questions electronically. The Child's questions and answers are both then sent to the Sponsor via text. For example, the text can say: “Max has finished The Phantom Tollbooth. Click here to see the questions he answered about the book and to approve his points.” The Sponsor then has the opportunity to review the answers to the questions and approve, deny, or ask to “discuss” the requested points.

If, instead of choosing to answer questions electronically, the Child chooses to discuss the answers in person with the Child's Sponsor, the Sponsor will be sent a random set of questions from the system to use as a basis for the ensuing discussion. The Sponsor can then ask the Child the questions and the Child answers them. After questions are answered to a Sponsor's satisfaction, a Sponsor can approve the points.

After completion, the Child can get a text or other electronic communications such as an email, SMS, Push Message or a message from within the system. For example, the message can say: “Congratulations. You just earned 900 points. Would you like to recommend this book to your friends?” Book recommendation can be sent to other Children that a Child has registered as friends and for whom the Child earns extra referral points.

The disclosed system has ways to make each Child's experience unique. For example, the system can know where each Child lives. Based on this location, the system can provide geo-centric, and therefore familiar, content. For example, if the Child lives in Minneapolis and is doing a math word problem trying to calculate baseball statistics, then that math problem could involve the Minnesota Twins. This same math problem may be given to a Child in Detroit, but could involve the Detroit Tigers instead.

The system can make content recommendations to Children based on their previous activities and their rating of these. Children are able to provide recommendations by, for example, using a star system for each module or activity they have completed.

Some Sponsors may be concerned with their Children interacting with strangers on the Internet, and some Children may want to interact with their friends on the Internet. To create a balance that makes both parents and Children happy, Children will be able to share information, but with limitations. In some embodiments, Children will be able to share information with other Members. In some embodiments, Children will be able to share information with Members a Sponsor has acknowledged or who the Child knows personally. The system can restrict the information that can be shared between Members to items such as, but not limited to, the amount of points a Child has earned, what a Child has redeemed their points for, and the rating of modules or other data or information that may be allowed by either the system or the Sponsor.

In one embodiment, Children can receive points as gifts from friends and relatives. For example, a grandparent can give a grandchild points for his or her birthday. These points can go into the Child's “extra credit” or “Gift Points” account. Gift Points can then be applied to the Member's account as Funded Points as they are earned. In one embodiment, Gift Points can be earned one-for-one (e.g. essentially “double points”), for any successful activity completed by the Child and approved by the parent until the “Gift Points” account is depleted. Gift Points can be added to a Child's account by entering a code assigned to the purchase. In some embodiments, those who purchase the Gift Points cannot approve or disapprove points, but can receive notification of a Child's progress. In some embodiments, a Sponsor can provide “read only” access to those who purchased the Gift Points so that the purchaser can see the Child's progress.

In some embodiments, a foundation or other organization or individual may sponsor Children whose parents do not have the resources to provide funded accounts for their Children. Foundations or other organizations can provide funding through an application and scholarship process.

In one embodiment, the system does not allow any typical or direct advertising to Children. The only advertising on the site may be limited to sponsored content (e.g. General Mills provides a module on nutrition) for Children and personalized recommendations of products for Sponsors based on the Sponsor's Child's activities in the system. The system may collect data on what Children like to do. Based on this information, the systems can make recommendations to parents regarding activities, merchandise, books, music, etc., that their Children will like.

In some embodiments, corporations are able to provide accounts to their employees and offer accounts as an employee benefit. A corporation can fund all, or just a portion of, a Child's points in a manner similar to traditional corporate matching programs. Foundations may also be Sponsors and provide funding for Children whose parents might not be able to afford funding of points and activities.

In addition to parent-funded points, the disclosed system offers other ways for Children to earn points. For example, Children are able to refer their friends. If a friend enrolls in the program and has Funded Points through the program, then the friend will become a “Recruit” for the Child. In some embodiments, the Child can earn 1 point for every 10 points the Recruit earns, provided that the Child meets a minimum threshold of earned points. That minimum threshold could be, for example, 1000 points in a calendar month. There may be limitations imposed on the number of Recruits allowed to each Child or the number allowed may be unlimited. Further, there may be a set time period after which a Recruit “expire” and the Child no longer receives points related to the expired Recruit. Expired Recruits can be replaced with new Recruits.

The system can have many promotional capabilities. For example, the disclosed system can allow Sponsors to offer double (or other) points for certain activities. The system may also enable businesses to offer a variety of promotions and sweepstake offerings to Members.

Additional features of the disclosed system include competition points between students or schools; recommendation engines; the sale and barter of points analogous to airline programs; student-created content and expansion globally in a variety of world languages. This system is not limited to English.

The system has tools that help a parent and Child understand what special abilities and interests each Child has. With this knowledge the system can create a better experience for each individual. A parent's dialogue with his or her Child may be elevated because each parent can have a better understanding of what makes their Child “tick”.

Tasks

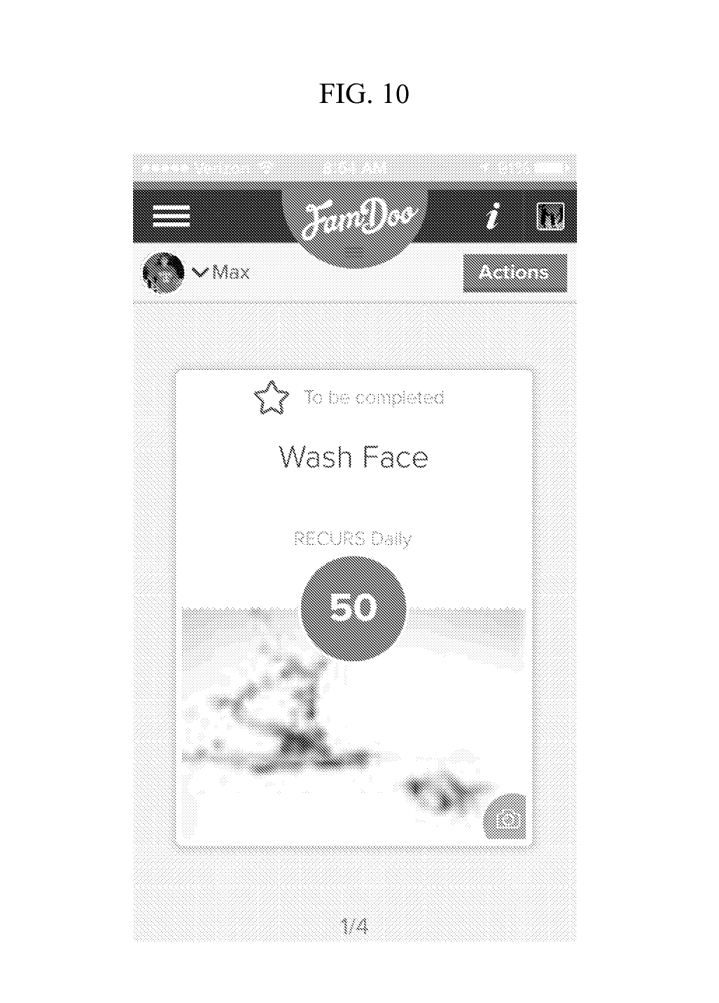

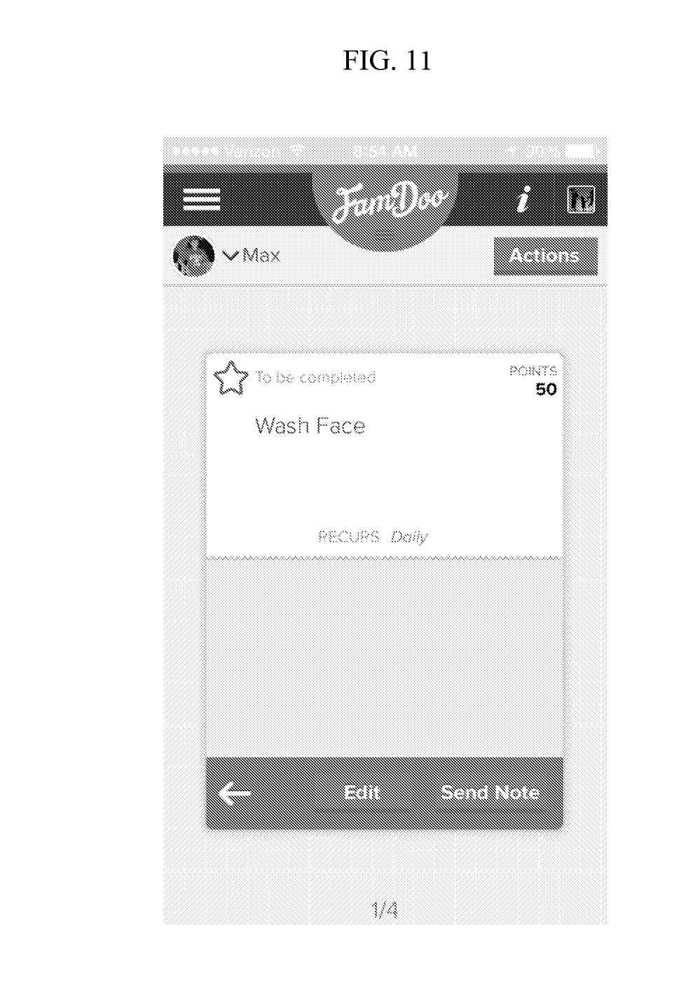

The Task List includes all assigned “Tasks” to each Child. The list may take on unique views based on the specific computing device being used, but the core list is made up of one or more Task Cards, as illustrated in FIGS. 10 and 11. Task Cards are patterned after the concept of a study flash card. They are intended to create a familiar visual interface allowing both Sponsor and Child to interact with, customize, and navigate through the Task Flow. How each task is displayed, sorted, and filtered is customizable by the Member and is designed to help Members navigate through their task completion cycle. For instance, tasks may be sorted or filtered by due date, category, or status.

Each Task Card has a visual front and back. The application uses unique animations to “flip” the card, (i.e., toggle between the front and back views). The front view of a Task Card, as illustrated in FIG. 10, contains information such as, but not limited to, the task status, task title, task frequency, point value, customizable task photo identifier, and preview. Additionally, the card contains “hot zones” that allow users to complete certain actions by selecting the corresponding button. The back view of a Task Card, as illustrated in FIG. 11, includes task's status, value, and frequency. It can also include the ability to attach notes and photos to the task. Further, it can display a history of all notes and photos associated with that task.

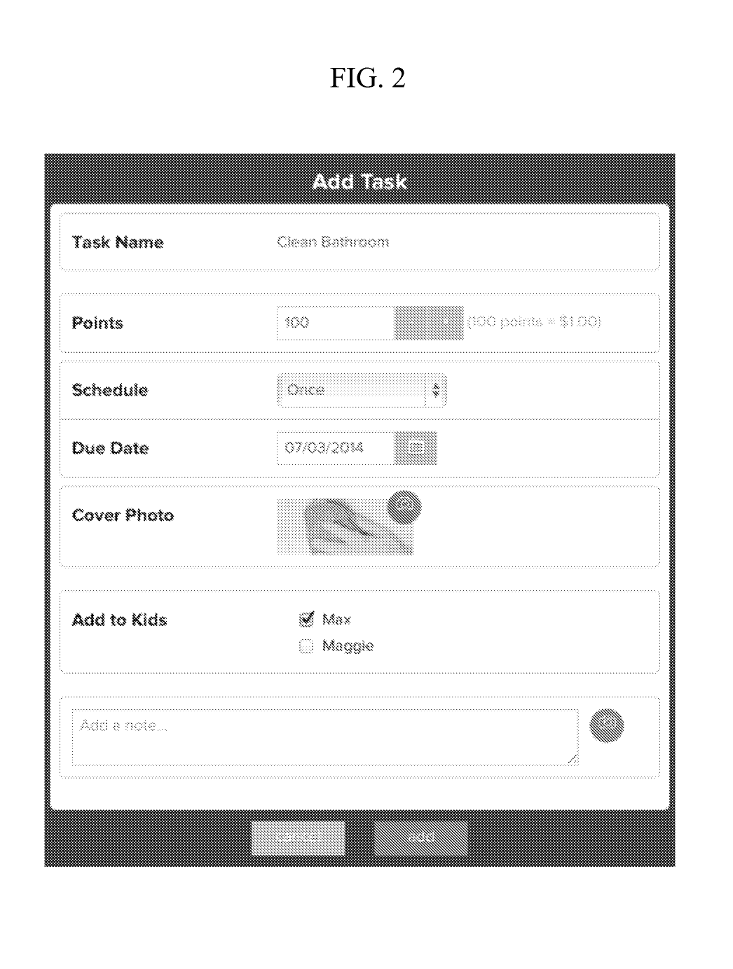

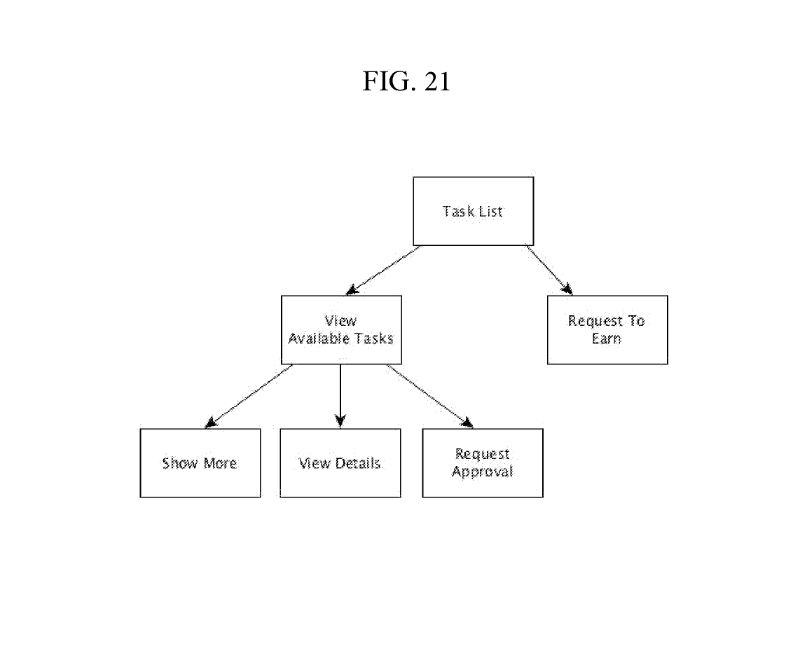

To add and assign a task to a Child, as illustrated in FIG. 2, the Sponsor can input information such as, but not limited to, the name of the task, the number of points the Child can receive upon completion of the task, the frequency of the task, the due date, a cover photo, the Child to whom the task will be assigned, and any notes. Within the Task List, a Child has the option to view available tasks or request to earn points, as illustrated in FIG. 21. If a Child decides to view available tasks, the Child can show more available tasks if only a few are showing, the Child can view details for a specific task, or the Child can request approval for a completed task.

The disclosed system allows tasks to be assigned and completed with various frequencies. For example, a task can be assigned and completed one time, on a recurring basis, or as needed. These frequency statuses allow Sponsors and Children to ease the burden of populating and managing the Task List for tasks that happen on a regular basis. For instance, “Make your Bed” can be assigned daily while “Take out the Garbage” may be assigned weekly or even bi-weekly. As Needed tasks allow for instances where Sponsors can observe a need and assign a task for a Child to complete whenever necessary. For example, “sweep the floor” or “study vocabulary” can be tasks that are always available for reward.

The disclosed system's customizable interface allows the Member to choose a photo from a gallery or choose a personal photo to represent the task. For instance, a picture of the family dog can represent “Feed the Dog.” In some embodiments, the representative photo is called a cover photo.

The disclosed system's content and functionality is enabled through the use of Tasks. Tasks can be pre-populated in the system or created by the end user. Tasks can be organized in a unique hierarchy allowing for a broad range of topics appealing to a wide range of Members. This organization also allows for unlimited growth in both breath (number topics) and depth (number of tasks). Task Categories begin at the highest level with “Do”, “Learn” and “Be”.

“Do” tasks are tasks that usually have no application-based content, instruction or assessment included with them. These include standard household chores, School Activities, Pet Care, etc. Examples are “Make your Bed” or “Clean your Room.”

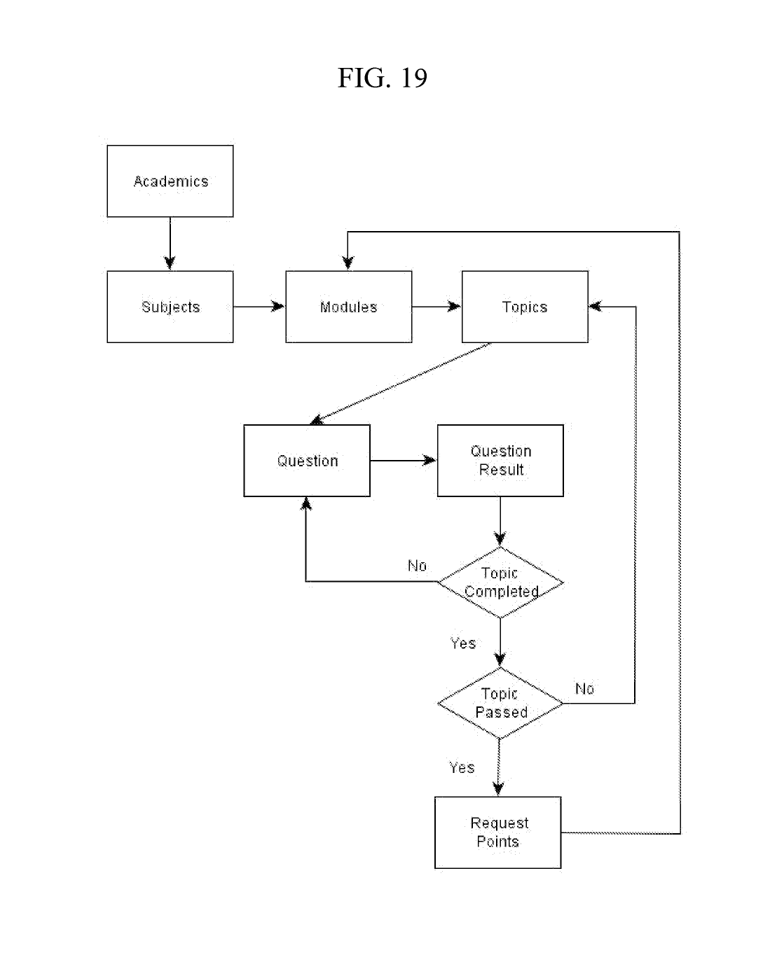

“Learn” tasks are educational modules. The function of these modules is to teach a particular academic subject like Math, Geography or Vocabulary. These tasks are further organized by grade level. Functionally, these tasks include educational content, a learning mechanism, such as flashcard-based learning, and a scored assessment. The process of completing a Learn task is illustrated in FIG. 19, according to one embodiment of the disclosed system. For example, a Child can select an academics task, narrow it down by subject, module, and topic, and then be presented with various questions. Once the Child answers all of the questions, the Child will see the results and the topic will be complete. At that time, the system can determine if the Child has passed the topic and, if so, the Child can request points from the Sponsor. If the Child has not passed, the Child may be able to re-try the topic's questions again.

“Be” tasks are intended to help Sponsors and Children learn, discuss, and practice subjects designed to enrich their lives or help them become better community citizens. Subjects in “Be” categories include “Values”, “Social Awareness”, “Financial Literacy”, “Health and Wellness”, etc. As with Learn Tasks, these can include educational content, a learning mechanism, and an assessment.

Pre-populated tasks in both the “Learn” and “Be” categories have activities and content included with them. For instance Math tasks include math “Flash Cards” and Quizzes as part of the task itself. Preview allows users to see the available content before the task is assigned.

Task interactions can be broken down into multiple forms depending on the requirements of the individual subject. In a preferred embodiment, there are three main elements to a task: Content, Learning Mechanism, and Assessment.

Content can be delivered in many forms including, but not limited to, written words, photographs, rich media (ex: audio and video), links to third party content viewed within the system, links outside of the system, or even live web-based interactions or discussions.

Learning Mechanisms can be delivered in multiple forms depending on the subject and content needs. These include flashcards, rich media, tactile response mechanisms, game play, visual or audible response, etc. These mechanisms are designed to utilize native functionality of the individual device being utilized. This functionality may include device interactions like cameras, video cameras, accelerometers, compass or geo coordinates, radiofrequency interactions or wide area network interactions.

Assessments are simply a way for the Child to show completion of a task. These may include, but are not limited to, multiple-choice quizzes, freeform text, rich media uploads (ex: photos, audio recordings or video), links to content created on third party environments, etc. Assessments can contain one or many of theses forms aggregated into one task. Again, these assessments may utilize native functionality of the devices being utilized.

The task's status represents where the task currently sits in the Task Cycle. In some embodiments, the stages of the tasks cycle have different titles for Children and Sponsors, but they represent the same task status. For example, the Sponsor's task status title for tasks that are assigned but not yet complete can be “To Be Completed,” whereas the Child's task status title could be “Tap to Complete.” An example Sponsor task status title for tasks that are completed by the Child, but not yet approved by the Sponsor can be “Completed.” The corresponding Child task status title can be “Waiting for Reward.”

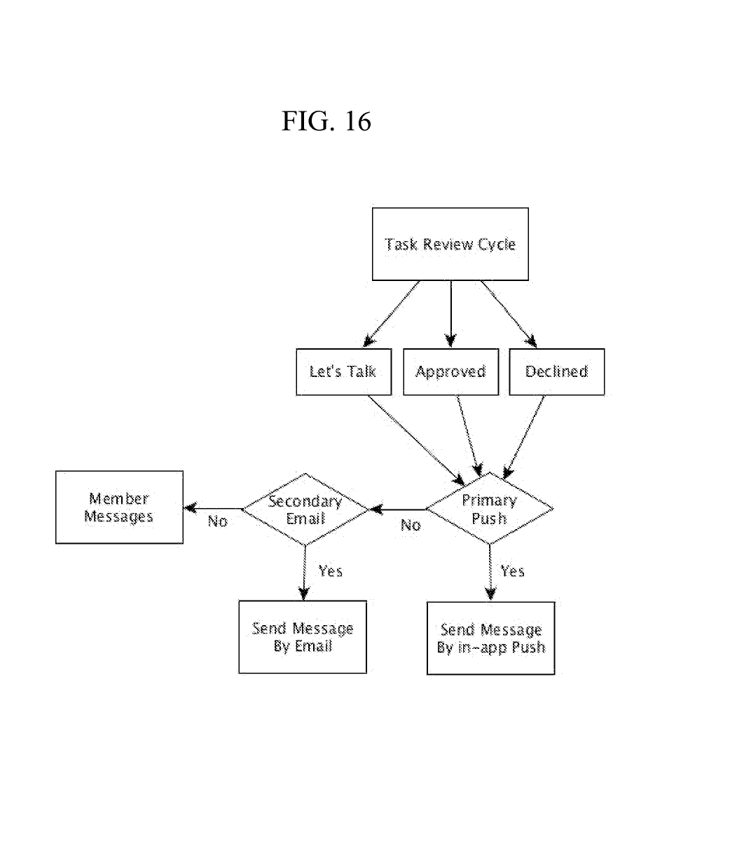

Once completed by the Child, Sponsors have three choices for interacting with the task, as illustrated in FIG. 16. One option is for a Sponsor to approve the task and allocate the task value to the Child's Points Bank. A second option is for the Sponsor to deny the task reward and remove it from the Task List. The third option is for the Sponsor to select a button such “Let's Talk.” This button allows the Sponsor to temporarily deny the reward, but keep the task active on the Child's Task List. For example, a Child may see his room as clean, but the Sponsor's expectations have not been met, so the Sponsor can select the “Let's Talk” button, talk to the Child, permit the Child to do a better job cleaning his room, and then permit the Child to re-request the reward. When any of these three options are selected, the system can respond in a number of ways, as illustrated by FIG. 16. The system can send a push notification, which directly sends a message to the Child. Alternatively, the system can send an email to the Child or the Sponsor can directly message the Child.

Payment of Points

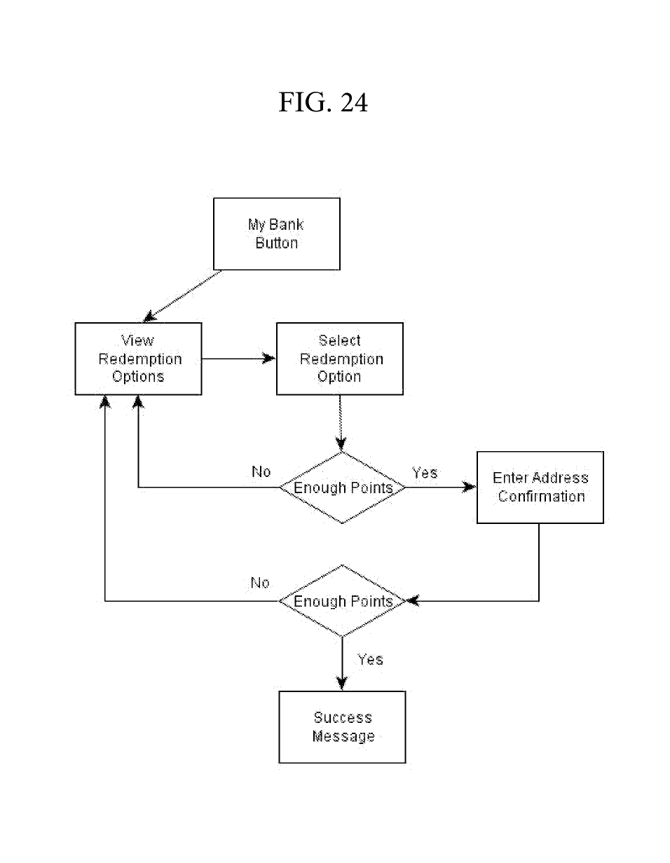

The Points Bank is an accounting repository for all points rewarded by Sponsors and available to Children. Points populate into the three main accounting buckets of Save, Spend, and Share. Once accrued, Children can request these points to be redeemed for a variety of items through an ecommerce platform. Once requested, Sponsors fund the request out of the Child's Points Bank. The process of redemption is illustrated in FIG. 24 and involves a Sponsor viewing redemption options, selecting a redemption option, and being informed by the system whether the Child has enough points. If the Child does, the Sponsor can enter address confirmation, the system will confirm that enough points are available for the redemption and, if enough points are available, the Sponsor will receive a success message indicating that the redemption has taken place. If, at any time, the system recognizes that not enough points are available for the selected redemption, it will indicate to the Sponsor that the Sponsor needs to view other redemption options.

Points allocated to the Save bucket are for saving, similar to a savings account. Children can request these points be converted into a savings account such as, but not limited to, a deposit into their savings account via direct deposit, a college savings plans (ex. 529 plans), etc. Points allocated to the Share bucket are for charitable giving. Children can request redemptions that will result in a donation to a charitable organization. Points allocated to the Spend bucket are for spending. Various mechanisms exist to spend points using the system such as, but not limited to, product selections, gift cards, song downloads, digital content, etc.

The Sponsor's Points Bank represent Funded Points and the balance available for Children to acquire through the completion of tasks. Points can be funded through numerous means including a credit or debit card, a PayPal account, an ACH or ETF transfer, Gift Points from a third party, payment from a corporation or foundation as a third party Sponsor, or any other current or payment systems. In some embodiments, the system accepts a unique form of payment for points. Sponsors are able to transfer points from other loyalty programs such as, but not limited to, a bank or hotel rewards card. These points can then fund a Child's points. For example, a person who has a US Bank FlexPerks Reward card can transfer his or her FlexPerks points to the system to pay for points. These points can also be funded through Sponsored Points.

The disclosed system is set up to allow for auto-replenish of points once a Child's account drops below a certain threshold. The auto-replenish feature can eliminate interruptions in the use of the system because an account is able to reload itself. For example, if a Sponsor buys 2000 points and chooses an auto-replenish option to trigger at 200 points, then, upon the account being depleted to 200 points, the account will automatically be “reloaded” with another 2000 points. This enables a Member to continue to participate without any interruptions.

Some of the benefits of the disclosed system and method to Children include, but are not limited to, the ability to earn money to purchase items they want; the ability to be on their mobile devices or computer; a consistent way to earn real rewards for doing tasks that parents approve of; a way to interact with friends regarding positive behaviors; and an easy way to explore individual interests.

Some of the benefits to parents include, but are not limited to, the simplicity and efficiency of the system; the ability to support Children's learning; availability of a tool that consistently tasks and rewards Children; the ability to monitor Children's learning; the ability to encourage Children to learn and earn money at the same time; a way to monitor a portion of Children's online usage; recommendations of other materials to help Children's learning or exploration; that ability to support Children in exploring their own interests; the ability to manage offline and online activities for Children; and the ability to customize experience.

Reports

Functional reports are available to Sponsors. These reports can be accessed through the system or delivered via email, sometimes automatically. The different reports that are available include, but are not limited to, sponsor sign-in reports, Child sign-in reports, completed academics, points earned, and redemption fulfillment.

In some embodiments, the Sponsor and Child sign-in report can be a summary report that groups previous sign-ins by time of day ranges, number of sign-in attempts, and device type. In some embodiments, the completed academics report can be a summary report of completed academics that is organized by subject, module, topic, or number of successful completions.

In some embodiments, the points earned report can be a summary report of total Funded Points earned, total Shared Points earned, total Saved Points earned, and total Points Redeemed. The Points Redeemed summary can be further broken out by each redemption option.

In some embodiments, the redemption fulfillment report may only be used if manual fulfillment is necessary. This report can show all redemptions that have not yet been processed and can have the ability for a Sponsor to select a “process” button that populates a processed field on the redemption report to remove it from the report. Fields on the report can include, but are not limited to, the Child's phone number and first and last name, the Sponsor's first and last name, the mailing address, the quantity of the redeemed item(s), the points redeemed, and the redemption description.

Website Content

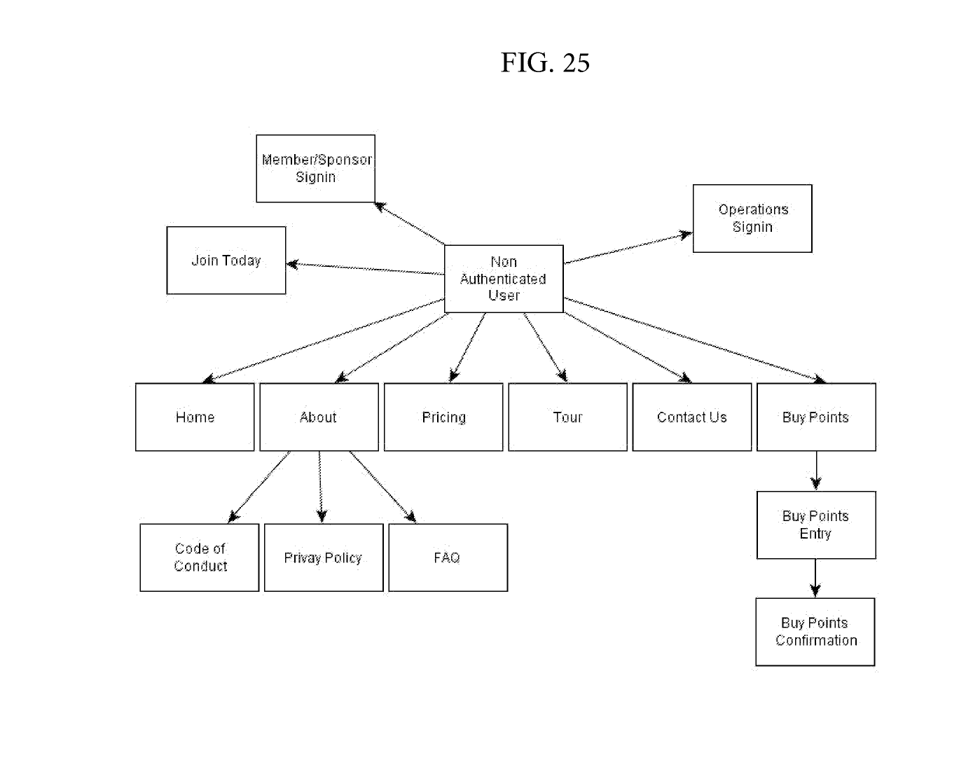

In some embodiments, the system can be used through a browser website by a non-authenticated user, which can contain several pages, as illustrated in FIG. 25. One page can be a Join Now page that allows a Member to create an account. The Member may be required to enter personal information and, if it a Sponsor creating an account, payment information. The system may require the Sponsor to create a username and password and may alert the Sponsor if the username is already taken. Further the system may allow for creation of password hints. In a preferred embodiment, Sponsors and Children will have separate and unique usernames.

Another page may be for Member information. Within this page, a Sponsor can set up the initial Save and Share percentages. The initial default distribution for earned points may be 5% each for Save and Share categories. However, a Sponsor can change the percentage to a desired value, including zero.

A membership payment page permits a Sponsor to select payment options and enter information into required fields. A nickname may be permitted to associate with the Sponsor's chosen form of payment. Each purchase transactions increments the available Funded Points for the Child.

The sign-in link can, in some embodiments, direct all Members through the same sign in process. Once a Sponsor or Child is signed in, the area for signing in can be replaced with a welcome message. The sign out link can be shown on every page. A download link can be supplied on a browser webpage that allows the user to download a mobile application.

In some embodiments, a Gift Points link, when selected, can enable a third party user to purchase a fixed amount of Gift Points to be given to a Child. Instructions may be presented to the third party user about how Gift Points apply to a Child's account along with instructions to present the gift code to the Child. The third party user may or may not specify the Child's account at the time of purchase.

The third party user can select the point amount to purchase, enter credit card information for payment, and submit the transaction. Upon successful credit card processing, the third party user can be shown a unique code value along with instructions to present the unique code to the Child. A confirmation email containing the gift code can be mailed to the third party user.

Additional Functionality

The disclosed system may include additional functionality and capabilities. In one embodiment, the system will provide the ability to calendarize activities as agreed to by a Sponsor and a Child, such that a Child knows what has been approved for earning and can plan accordingly. Another function can be a calculator function that allows a Sponsor or a Child to be able to input various activities to ascertain the total points that can be earned within a given time period or by participating in specific activities and tasks.

In one embodiment, a Child can see a daily, weekly, monthly, or annual calendar that shows what the Child can do to maximize his or her earning potential. The calendar can also show a Child the activities that have been approved by a Sponsor for earning points. This feature can be on a push or pull basis. For example, a Child can receive calendar information in an email or text. On the other hand, a Child may see this information upon logging into his or her account. In one embodiment, a Child can “request approval for an activity,” and the request can be sent to a Sponsor prior to that activity being undertaken so that a Child knows whether he or she will be able to earn points for the activity. A Sponsor may be provided with the request and can respond with an approval, denial, or “let's discuss” options.

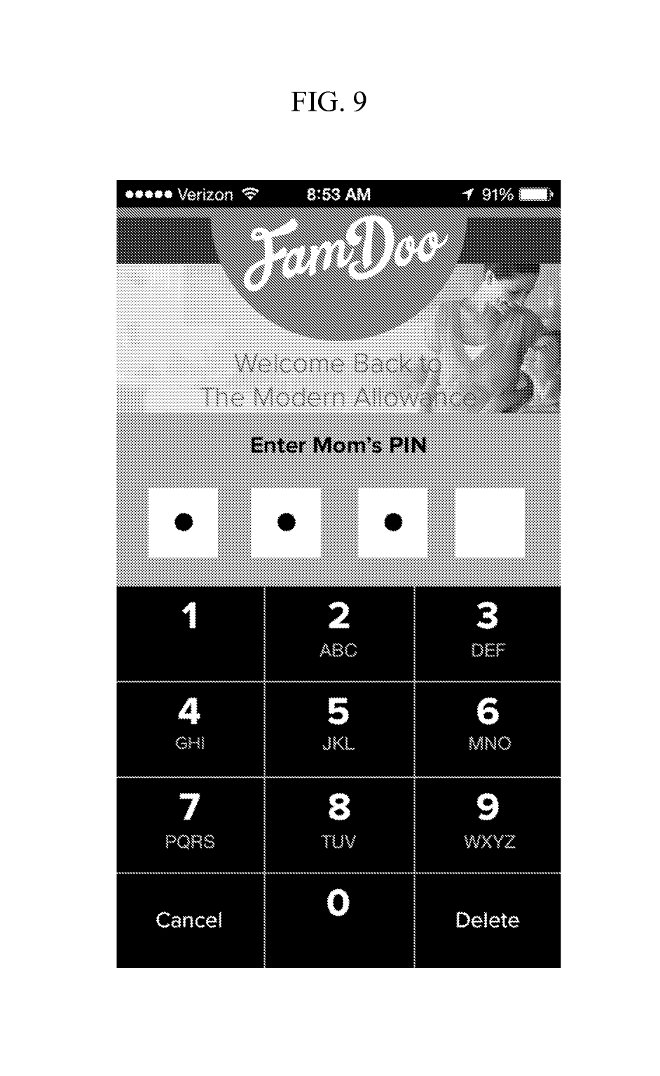

The user experience for the disclosed system can address possible scenarios that are unique to the construct of the system. Because the system is a single account (the Sponsor account), multi-user (different Children), multiple-shared device situation, a family may share a device. In this situation, the system permits each Member to login to the system easily and quickly without needing to re-enter a full username and password each time. It does this by allowing a Member to use a 4-digit pin code, as illustrated in FIG. 9, once a Member has, at least once, logged into the device with a full username and password. This structure aids in the speed and efficiency with which family members can use shared devices. The system can be used on any web-enabled device.

The user-interface includes a “Task Tile”. This Task Tile feature is loosely based on the idea of a learning flash card. The Task Tiles represent a more interactive view of a “Task List” making the application more intuitive. They are also a place to capture and display all activity and messages associated with the task itself.

In some embodiments, the disclosed system contains a subscribed Task List option, wherein a Child can subscribe to tasks that are created by a third party. For example, a Child may subscribe to a homework feed from a teacher or a practice regimen from a coach. This feature allows for a more inclusive and extensive user experience.

In some embodiments, one or more of the following features may exist: Free Points can be converted to Funded Points; Funded Points can be transferred between accounts or redeemed across multiple accounts; Recruit accounts can be linked to a Child's account within a certain number of days; a Child's progress can be tracked as they complete a task and as they progress towards a goal; feedback can be given at the end of a lesson; a Sponsor may not be allowed to turn off the academics tasks; enrollment bonuses, in the form of points or external fulfillment, may be offered; video tutorials can be included as part of lessons; username help can be provided at the time of login; content feedback can be provided; a Sponsor can provide Gift Points to a Child that the Sponsor does not know; recurring Gift Points can be given by a third party user, which may be cancelled at any time; and social media login may be provided for Children.

Technical System

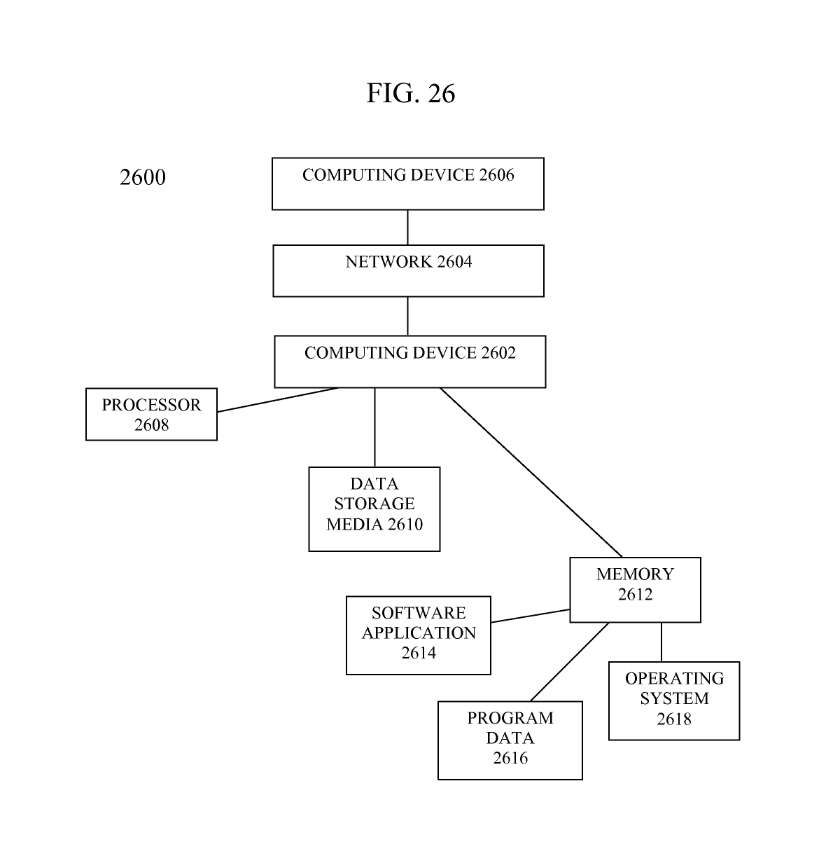

The disclosed system is computer-implemented and uses a computing system. FIG. 26 is a schematic block diagram of an example computing system 2600. The example computing system includes at least one computing device 2602. In some embodiments the computing system further includes a communication network 2604 (such as the internet or a cellular network) and one or more additional computing devices 2606 (such as a server).

The computing device 2602 can be, for example, a smart phone or other mobile device, a tablet computing device, a netbook, a computing device located in a user's home or office, or any other computing device. The computing device 2602 can be a stand-alone computing device or a networked computing device that communicates with one or more other additional computing devices 2606 across a network 2604. The additional computing device(s) 2606 can be, for example, located remotely from the initial computing device 2602, but configured for data communication with the initial computing device 2602 across a network 2604. The additional computing device 2606 can be, for example, a server.

In some examples, the computing device 2602, 2606 includes at least one processor or processing unit 2608 and system memory 2612. The processor 2608 is a device configured to process a set of instructions. In some embodiments, system memory 2612 may be a component of the processor 808; in other embodiments, system memory 2612 is separate from the processor 808. Depending on the exact configuration and type of computing device, the system memory 2612 may be volatile (such as RAM), nonvolatile (such as ROM, flash memory, etc.), or some combination of the two. System memory 2612 typically includes an operating system 2618 suitable for controlling the operation of the computing device, such as the WINDOWS® operating systems from Microsoft Corporation, or a server, such as Windows SharePoint Server, also from Microsoft Corporation. To provide further example, if the computing device 2602 is a smart phone or other mobile device, the operating system may be iOS, WP7, or any other available mobile operating system. The system memory 2612 may also include one or more software applications 2614 and may include program data 2616. The software applications may be in the form of mobile applications in examples wherein the computing device 2602 is a mobile device.

The computing device 2602 may have additional features or functionality. For example, the computing device 2602 may also include additional data storage devices 2610 (removable and/or non-removable) such as, for example, magnetic disks, optical disks, or tape. Computer storage media 2610 may include volatile and nonvolatile, removable and non-removable media implemented in any method or technology for storage of information, such as computer readable instructions, data structures, program modules, or other data. System memory, removable storage and non-removable storage are all examples of computer storage media 2610. Computer storage media 2610 includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing device. An example of computer storage media 2610 is non-transitory media. The computing device 2602 may include data storage media 2610 such as the data storage media described above, on which data is stored.

In some examples, one or more of the computing devices 2602, 2606 can be located in a venue or place of business. In other examples, the computing device 2602, 2606 can be a personal computing device that is networked to allow the user to access the system disclosed herein at a remote location, such as in a user's home or other location. In some embodiments, the computing device 2602 is a smart phone, tablet, laptop computer, personal digital assistant, or other mobile device. In some embodiments some components of the disclosed system are stored as data instructions for a smart phone application. A network 2604 facilitates communication between the computing device 2602 and one or more servers, such as an additional computing device 2606 that hosts the disclosed system. The network may include a wide variety of different types of electronic communication networks. For example, the network 2604 may be a wide-area network, such as the Internet, a local-area network, a metropolitan-area network, a cellular network or another type of electronic communication network. The network 2604 may include wired and/or wireless data links. A variety of communications protocols may be used in the network 2604 including, but not limited to, Ethernet, Transport Control Protocol (TCP), Internet Protocol (IP), Hypertext Transfer Protocol (HTTP), SOAP, remote procedure call protocols, and/or other types of communications protocols.

In some examples, the additional computing device 2606 is a Web server. In this example, the initial computing device 2602 includes a Web browser that communicates with the Web server to request and retrieve data. The data is then displayed to the user, such as using a Web browser software application. In some embodiments, the various operations, methods, and rules disclosed herein are implemented by instructions stored in memory. When the processor 2608 of one or more of computing devices 2602, 2606 executes the instructions, the instructions cause the processor 2608 to perform one or more of the operations or methods disclosed herein.

The system and method can also include location-data captured by a GPS-enabled application or device. The computing device 2602 may also have Wi-Fi or 3G capabilities.

The various embodiments described above are provided by way of illustration only and should not be construed to limit the scope of the disclosure. Those skilled in the art will readily recognize various modifications and changes that may be made without following the example embodiments and applications illustrated and described herein and without departing from the true spirit and scope of the invention.

What is claimed is:

1. A method of tracking and rewarding the completion of activities comprising:
utilizing a networked computing device having a processing device and a memory device, the memory device storing information that, when executed by the processing device, causes the processing device to:
allow a first user to create an assigned activity for a second user;
send the assigned task to the second user;
display the assigned task to the second user;
allow the second user to indicate completion of the assigned activity;
allow the second user to request a reward from the second user for completing the assigned activity;
send the second user's notice of completion and request for the reward to the first user;
display the notice of completion and request for reward to the first user;
allow the first user to indicate acceptance, denial, or temporarily denial of the request;
send the acceptance, denial, or temporary denial to the second user;
display the acceptance, denial, or temporary denial to the second user;
allow the first user to update the temporary denial to be an acceptance or denial;
send the updated acceptance or denial to the second user; and
display the updated acceptance or denial to the second user.

2. The method of claim 1, wherein the assigned activity is chosen from one of the several categories of academics, health, finances, family, and community.

3. The method of claim 1, wherein the reward is at least one point.

4. The method of claim 3, wherein the first user purchases points to use as the reward for the second user.

5. The method of claim 3, wherein the at least one point can be exchanged for products or services of monetary value.
